(19) United States
(12) Patent Application Publication
(10) Pub. No.: US 2010/0263479 A1
(43) Pub. Date: Oct. 21, 2010

(54) INERTIAL ENERGY STORAGE SYSTEM

(76) Inventors: Richard C. Thompson, Austin, TX (US); Brian Murphy, Austin, TX (US)

Correspondence Address: Ballard Spahr LLP, SUITE 1000, 999 PEACHTREE STREET, ATLANTA, GA, 30309-3915, US

(21) Appl. No.: 12/764,777

(22) Filed: Apr. 21, 2010

Related U.S. Application Data
(60) Provisional application No. 61/171,282, filed on Apr. 21, 2009.

(51) Int. Cl. H02K 7/02

(52) U.S. Cl. 74/572.1

(57) ABSTRACT

Inertial energy storage systems are provided that include a generator and a rotor system. Non-rotating and rotating components of the system, such as a generator and a flywheel, are supported compliantly through the use of a gimbal system. The purpose-designed gimbal has software algorithms for proper operational control of an axially elongated pendulum flywheel. The inertial energy storage system further includes a mechanical adjustment system for permitting initial alignment of the generator and the rotor system so that the mass and geometric centers of the rotor system can be substantially co-axially aligned.

### FIELD OF THE INVENTION

A kinetic energy storage system is presented herein. More specifically, aspects of a low-cost, scalable inertial energy storage system using a high speed rotor are presented.

### BACKGROUND OF THE INVENTION

Generated electrical energy is instantaneously consumed. Over the last several decades, storage approaches have been aggressively pursued including chemical battery, inertial, magnetic, compressed air, pumped hydro, hydrogen (hybrid), and capacitor-based systems. None of these have satisfied the non-site specific and needed commercial metrics including low maintenance and low cycle life cost for large-scale energy storage.

Conventional inertia energy storage devices store energy in a rotor levitated by mechanical or magnetic bearings on either end. Rotordynamic limits, oversizing the bearings to handle the extremely large rotor weight, large stator structures to support the bearing mounts, complex thermal management, and associated costs for these components are problematic.

Using a vertical mount with a magnetic thrust bearing provides a less complex, lower cost solution for resolving the high rotor weight. However, a phenomenon associated with high speed rotors suspended in a pendulum-like fashion is that of a dynamic whirling instability. During a normal startup, rotors of this sort pass through a pendulum mode. Typically this happens at very low speed. As the rotor continues on to high speed, the low frequency pendulum mode is susceptible to a dynamic whirling instability triggered by hysteresis within the rotating assembly. The instability prevents the rotor from being operated at high speed. Usually there is some “threshold speed” above which the rotor cannot be run, and often this speed is not very far above the speed of the pendulum mode. Thus, there is a need in the art for developing a vertically-mounted inertial energy system with improved stability.

### SUMMARY

In accordance with the purpose(s) of this invention, as embodied and broadly described herein, an inertial energy storage system is presented herein. In one aspect, the energy storage system can comprise at least one of a rotor, a bearing system, and a generator. In another aspect, the rotor can comprise an inertial rim (or flywheel) configured for storing rotational energy. In one embodiment, the components of the inertial energy storage system can be positioned in a substantially vertical arrangement, and the rotor can be suspended in an excavated pit.

In one aspect, the flywheel can be an elongated member having a high axial length-to-diameter ratio. In another aspect, the flywheel can be an elongated, substantially tubular-shaped member having a predetermined mass and a predetermined wall thickness. The high length-to-diameter ratio of the flywheel allows for large scale energy storage levels when the flywheel is operatively coupled to the controlled bearing system.

In another aspect, however, the flywheel can be an elongated, substantially frusto-conically shaped member having a predetermined mass. Thus, in this aspect, the flywheel can be tapered, relative to the longitudinal axis, from a proximal end of reduced diameter to a distal end of expanded diameter. By using a radial taper angle between the proximal end and the distal end of the flywheel, the flywheel can have a pronounced difference in finished diameters between its proximal end and its distal end. The reduced diameter of the proximal end of the tapered flywheel can, in one aspect, provide a more accurate and secure attachment point for operatively coupling the flywheel to the generator.

In one exemplary aspect, the inertial energy storage system can further comprise a mechanical adjustment means designed to permit initial and in-service alignment of the generator and the rotor. It is contemplated that the mechanical adjustment means can allow the rotor and the generator to be substantially aligned so that the mass and geometric centers of the rotor would be substantially co-axially aligned.

In another aspect, the inertial energy storage system can further comprise a gimbal system configured for supporting at least a portion of the non-rotating components and/or the rotating components of the system compliantly instead of substantially rigidly. In still another aspect, the gimbal system can allow the non-rotating and/or the rotating components to gimbal or move in a desired or otherwise predetermined manner while providing the desired amount of support stiffness and damping to defeat the detrimental effects of any dynamic instability associated with the suspended rotor.

Additional advantages of the invention will be set forth in part in the description that follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several aspects of the invention and together with the description, serve to explain the principles of the invention.

FIG. 1 is a schematic illustration showing select components of an exemplary operating environment for the disclosed system.

FIG. 2 is a cross-sectional elevational diagram of an inertial energy storage system, according to one embodiment, comprising a substantially tubular shaped flywheel.

FIG. 3 is a cross-sectional elevational diagram of an inertial energy storage system, according to another embodiment, comprising a substantially frusto-conically shaped flywheel.

FIG. 4 is a perspective view of a gimbal system and portions of a rotor system of the inertial energy storage system of FIG. 2.

### DETAILED DESCRIPTION OF THE INVENTION

The present invention may be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

As used in the specification and the appended claims, the singular forms “a,” “an” and “the” include plural referents unless the context clearly dictates otherwise. Thus, for example, reference to a “flywheel” can include two or more such flywheels unless the context indicates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Reference will now be made in detail to the present aspects of the inertial energy storage system, examples of which are illustrated in the accompanying drawings. Wherever possible, the same reference numbers are used throughout the drawings to refer to the same or like parts.

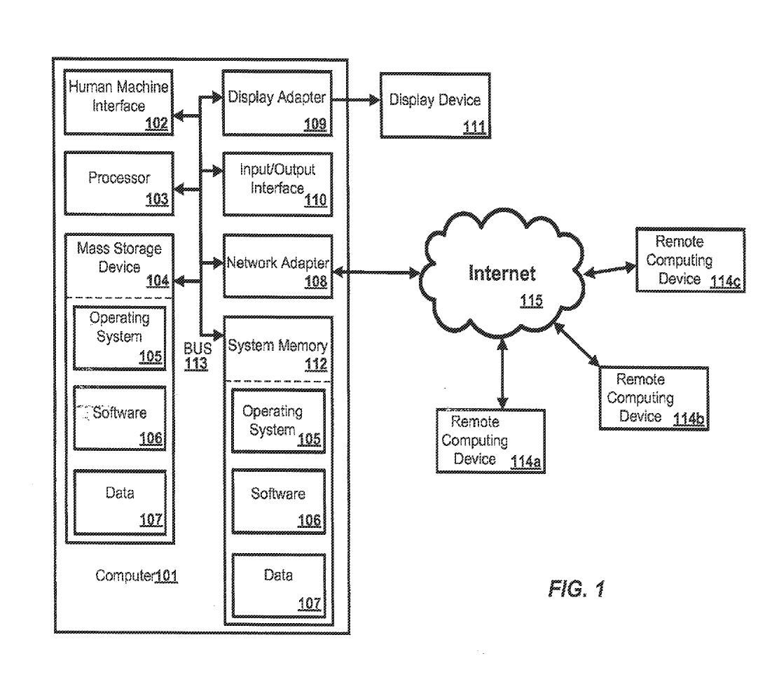

FIG. 1 is a schematic block diagram illustrating an exemplary operating environment for performing the disclosed methods and portions thereof. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, hand-held electronic devices, vehicle-embedded electronic devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. In one aspect, the program modules can comprise a system control module. The disclosed method can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the system and method disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus also known as a Mezzanine bus. The bus 113, and all buses specified in this description can also be implemented over a wired or wireless network connection and each of the subsystems, including the processor 103, a mass storage device 104, an operating system 105, gimbal system software 106, gimbal system and/or rotor positional and/or rotational data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as gimbal system and/or rotor positional and/or rotational data 107 and/or program modules such as operating system 105 and gimbal system module software 106 that are immediately accessible to and/or are presently operated on by the processing unit 103.

In another aspect, the computer 101 can also comprise other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and gimbal system module software 106. Each of the operating system 105 and gimbal system module software 106 (or some combination thereof) can comprise elements of the programming and the gimbal system module software 106. Gimbal system and/or rotor positional and/or rotational data 107 can also be stored on the mass storage device 104. Gimbal system and/or rotor positional and/or rotational data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 110.

The computer 101 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computer 101 and a remote computing device 114a,b,c can be made via a local area network (LAN) and a general wide area network (WAN). Such network connections can be through a network adapter 108. A network adapter 108 can be implemented in both wired and wireless environments. Such networking environments are conventional and commonplace in offices, enterprise-wide computer networks, intranets, and the Internet 115.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of gimbal system software 106 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

In various aspects, it is contemplated that the methods and systems described herein can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. expert inference rules generated through a neural network or production rules from statistical learning).

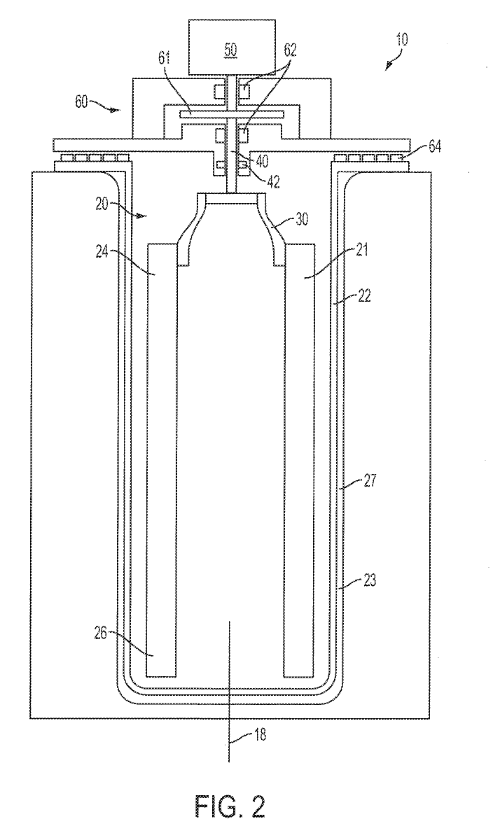

Referring now to FIG. 2, in one aspect, the inertial energy storage system 10 comprises at least one of a rotor system 20, a bearing system 60, and a generator 50. In another aspect, the rotor system can comprise an inertial rim 21 (or flywheel) having a longitudinal axis 25 and configured for storing rotational energy. In still another aspect, the rotor system 20 can comprise an arbor 30. In yet another aspect, the rotor system can further comprise a quill shaft 40. In one exemplary aspect, the inertial energy storage system components can be positioned in a vertical arrangement, as illustrated in FIG. 1, such that the flywheel 21 is suspended in a pendulum-like manner from the bearing system 60.

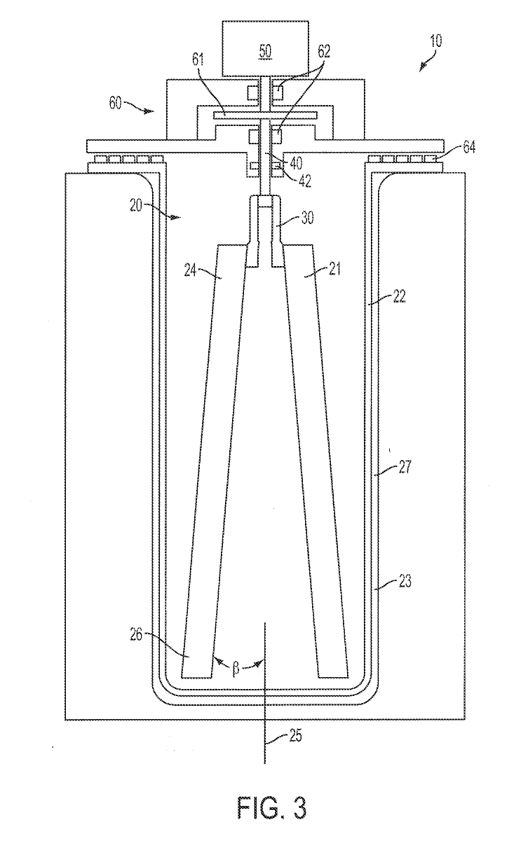

In one aspect, as illustrated in FIGS. 2 and 3, the rotor system can be suspended by the bearing system 60 and contained in a container 27. In another aspect, the container can be an excavated pit 23 or similar sub-surface arrangement. In another aspect, the inertial energy storage system 10 can be configured to reduce the effects of aerodynamic drag on the rotor system 20 when in motion by lining the container with a fiberglass vacuum barrier 22 and/or other air-tight material. In this aspect, at least a portion of the air and/or gases in the container can be evacuated from the container 27 to reduce the frictional forces acting on the flywheel as it rotates. In another aspect, however, it is contemplated that the rotor system can be contained in an above-ground container. In still another aspect, it is also contemplated that the rotor system 20 can be contained in a non-air-tight container.

According to one aspect, the flywheel 21 can be an elongated member having a relatively high axial length-to-diameter ratio. In one aspect, the axial length-to diameter ratio can be at least 100/1. In another aspect, the axial length-to diameter ratio can be at least 75/1. In another aspect, the axial length-to diameter ratio can be at least 50/1. In another aspect, the axial length-to diameter ratio can be at least 40/1. In another aspect, the axial length-to diameter ratio can be at least 30/1. In another aspect, the axial length-to diameter ratio can be at least 20/1. In another aspect, the axial length-to diameter ratio can be at least 10/1. In another aspect, the axial length-to diameter ratio can be at least 5/1. The high length-to-diameter ratio of the flywheel, with a specially designed and uniquely controlled gimbal system 70 can achieve large scale energy storage levels.

In another aspect, the flywheel 21 can be an elongated, substantially tubular shaped member having a predetermined mass and a predetermined wall thickness, as illustrated cross-sectionally in FIG. 2. Alternatively, in another aspect, the flywheel 21 can be an elongated, substantially frusto-conically shaped member having a predetermined mass, as illustrated cross-sectionally in FIG. 3. Thus, in this aspect, the flywheel can be tapered from a proximal end 24 to a distal end 26 relative to the longitudinal axis 25. By using an aggressive radial taper angle β between the proximal end and the distal end of the flywheel 21, the flywheel can have a pronounced difference in finished diameters between its proximal end and its distal end. As known to one of skill in the art, rotating materials can expand in size radially when rotating, due to assembly-induced stresses and/or spin-induced stresses. Also, as known to one of skill in the art, a smaller diameter rotating material will typically expand less than a larger diameter rotating material. Thus, the smaller diameter of the proximal end 24 of the tapered flywheel can, in one aspect, provide a more accurate and secure attachment point for operatively coupling the flywheel 21 to the generator 50, as described more fully below.

In one aspect, the flywheel 21 can be formed of composite reinforced materials, such as for example and without limitation, carbon fiber and glass. In another aspect, the flywheel can be formed from a combination of composite reinforced materials and metallic structures, and/or an all-metallic structure. In another aspect, the fiber selection and fiber orientation for the composite reinforced materials, with or without metallic structures, can be configured to uniquely tune the lateral (i.e., bending) stiffness of the rotor system 20 so that its first elastic mode is beyond (i.e., outside) the predetermined operating speed range of the flywheel. In this aspect, orienting the fibers can comprise achieving the correct balance of circumferentially and axially oriented fiber placement for mitigation of operating stresses and strains. In various other aspects, design of the flywheel 21 can comprise a changing blend of these fibers and their orientation along the length of the flywheel. Thus, the lateral (bending) stiffness of the flywheel throughout the length of the flywheel 21 can differ to ensure the correct first elastic mode properties needed for proper flywheel system operation. In other aspects, the rotor system can be balanced in-situ using proper placement of balance weights, such as for example and without limitation, metal inserts, tungsten powder, and/or epoxy mixtures, on a surface of the rotor system 20, and/or by removing material from the rotor system in a proper place on a surface of the rotor system.

The quill shaft 40, in one aspect, can be a flexible quill shaft, as known in the art. In another aspect, in order to maintain the rotor system 20 in a vacuum, sealing of the quill shaft can be accomplished using a shaft sealing device 42 such as, for example and without limitation, a ferro-fluidic, face, or segmented carbon seal and the like.

The arbor 30 can be a conventional strain-matching arbor configured to operatively connect the flywheel 21 to the quill shaft 40. In one aspect, the inertial energy storage system 10 can further comprise a mechanical adjustment means for permitting initial alignment of the generator and the rotor system so that the mass and geometric centers of the rotor system 20 can be substantially co-axially aligned. In another aspect, the mechanical adjustment means can be located where the quill shaft 40 attaches to the arbor, thereby permitting initial alignment of the arbor 30 of the rotor system and the quill shaft so that the arbor and the quill shaft 40 can be substantially aligned within a desired degree of precision. In this aspect, the mechanical adjustment means can be positioned thereon the rotor system located such that it is capable of rotating with the rotor system 20. In a further aspect, it is contemplated that the mechanical adjustment means is movable biaxially therein a substantially horizontal plane. In another aspect, the mechanical adjustment means can utilize highly precise approaches to alignment, such as, for example and without limitation, at least one adjustment screw and the like.

A top-mounted motor/generator 50 can be operatively coupled to the rotor system 20. In one aspect, the generator can be operatively connected to the quill shaft 40 so that the generator can selectively drive or be driven by the rotor system. In another aspect, the generator can be a conventional motor/generator configured to either drive the rotor system to rotate or to convert rotational energy from the rotor system into electrical energy as desired.

According to one aspect, the bearing system 60 can comprise a passive or active magnetic thrust bearing 61. In another aspect, the passive or active magnetic thrust bearing can be a repulsive or attractive permanent magnetic bearing configured to support the weight of the rotor system 20. In another aspect, the thrust bearing can be a superconducting magnet system which offers very low losses for extended operation at speed. In one aspect, the bearing system 60 can further comprise at least one conventional bearing 62. In another aspect, the at least one conventional bearing can be configured and positioned to stabilize lateral (i.e., radial) forces from both spin-induced vibrations and the off-setting forces associated with the passive or active magnetic thrust bearing 61. In still another aspect, the at least one conventional bearing can comprise at least one of a radial rolling element bearing or a radial magnetic bearing.

As discussed above, a phenomenon associated with high speed rotor systems suspended in a vertical, pendulum-like fashion is that of a dynamic whirling instability. In one aspect, the quill shaft 40 can provide low stiffness that produces the low frequency pendulum mode when installed as part of the inertial energy storage system 10. When the storage system is operating at high speed, hysteresis in the quill shaft can cause the instability.

The inertial energy storage system 10 presented herein can counteract at least a portion of the dynamic whirling instability. In one aspect, the inertial energy storage system 10 can counteract the instability by introducing asymmetry in the structural stiffness of suspended non-rotating and rotating components, such as, the generator 50 and its housing, the bearing system 60, the rotor system 20 and the like. In another aspect, supporting these suspended components compliantly through the use of a gimbal system 70, can significantly elevate the threshold operating speed. In yet another aspect, each degree of motion of the gimbal can be passively damped and/or actively damped. In another aspect, the compliance can be asymmetric (i.e., softer in one direction), elevating the threshold operating speed even further. In still another aspect, at least a portion of the non-rotating and/or the rotating components of the inertial energy storage system can be positioned on elastomeric dampers 64 to further reduce vibration in the rotor system.

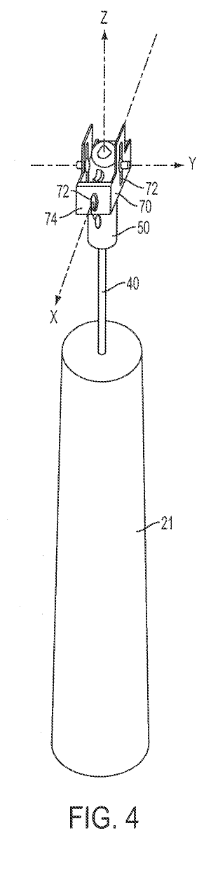

FIG. 4 illustrates a motor/generator 50 supported in a two axis gimbal 70, according to one aspect. In this aspect, an elongated flywheel 21 is suspended from the motor/generator by the quill shaft 40. Gravity acting on the massive flywheel can produce the low frequency pendulum mode mentioned above. As illustrated in FIG. 4, the motor/generator, when supported in the gimbal 70 capable of articulating the motor/generator over at least one degrees of motion can permit whirl motion control on the non-rotating and rotating components of the inertial energy storage system 10 for stable operation with a substantially tubular, elongated flywheel 21.

In another aspect, stiffness asymmetry in the supporting structure (the gimbal 70 in this case) can be introduced, by having the two gimbal axes (labeled X and Y in FIG. 4) be offset from each other. In this aspect, for example, the axes of the gimbal can be at different vertical heights. In another aspect, the gimbal 70 can comprise components to introduce a desired level of damping for stable operation and control of the rotor system 20. In one aspect, slots, such as vertical slots 72, can be defined in a gimbal frame 74 surrounding the motor/generator 50, to introduce such offset. In still another aspect, stiffness asymmetry can be introduced by adding a torsional spring on one or both gimbal axes. In addition to the passive gimbal control described above, in another aspect, the gimbal 70 may also be actively controlled by hydraulic, electromechanical, and/or electromagnetic actuators, or by any combinations of passive or active control.

In still another aspect, stiffness asymmetry can enhance stability because stiffness asymmetry can cause the natural whirling pattern of the high speed flywheel 21 to be elliptic rather than circular (whirling patterns are commonly referred to as “mode shapes” in technical literature on machine dynamics). As known in the art, elliptic patterns typically have better stability qualities compared to circular patterns.

According to one aspect, the gimbal system 70 can be a one or two-axis gimbal system. In another aspect, the gimbal system can allow the suspended non-rotating and rotating components to gimbal or move in a predetermined manner while providing the desired amount of support stiffness and damping to at least partially offset the detrimental effects of any dynamic instability associated with the pendulum rotor system. In still another aspect, the gimbal system can be passively and/or actively controlled and can comprise at least one hydraulic, electromechanical, and/or electromagnetic actuator or actuator system. In a further aspect, the gimbal system can further comprise at least one passive and/or active magnetic bearing 61 to react against the rotating quill shaft 40, thereby providing further damping. In yet another aspect, the gimbal system 70 can comprise a compliant sealing interface to maintain a vacuum around the rotating flywheel 21, if desired.

In an exemplary aspect, the inertial energy storage system 10 can further comprise a processor 103 electrically coupled to the gimbal system 70 with purpose-designed control algorithms to reduce the dynamic instability of the axially elongated, pendulum-suspended flywheel systems. In this aspect, feedback can be provided to the processor comprising at least one of the position, the velocity, and/or the acceleration of the spinning rotor system 20 and/or the non-rotating components of the inertial energy storage system 10. The processor 103 can calculate what motion, if any, should be selectively taken by the gimbal system 70 to counteract the dynamic instability of the rotor system 20 by moving the non-rotating components of the system. The processor can, in another aspect, actuate the at least one hydraulic, electromechanical, and/or electromagnetic actuator or actuator system described above to selectively move and/or selectively position the non-rotating components accordingly.

When assembled as described herein, the inertial energy storage system 10 enables the bearing system 60 and the generator 50 to operate outside the vacuum enclosure created by the vacuum barrier and the seal(s) of the quill shaft 40. This arrangement also provides the bearing system and the generator at ground level for simplified maintenance accessibility.

In use, the generator 50 can provide rotational energy through the quill shaft 40 and the arbor 30 to the elongate flywheel 21. In one aspect, an input signal comprising at least one of position, velocity, or acceleration of the rotor system 20 can be sent to the processor 103. The algorithm of the processor can determine a desired position, velocity and/or acceleration the gimbal system 70 should take to at least partially offset any dynamic instability present in the rotor system 20. In another aspect, the processor can send an output signal to the gimbal system 70 indicative of an action that the actuator or actuator system of the gimbal system should take. For example, the output signal could instruct the actuator or actuator system to move the rotor in a first direction at a first velocity to a first position. In another aspect, the motion of the rotor system 20 caused by the gimbal system 70 can counteract at least a portion of the dynamic instability of the rotor system.

The elongate shape of the flywheel when in motion tends to increase the dynamic instability of the rotor system 20; however, this dynamic instability can at least be partially offset by the gimbal system 70 to allow the rotor to operate at higher speeds, thereby storing greater amounts of rotational energy. Thus, when compared to conventional rotational energy storage systems, the inertial energy storage system of the present application can provide lower cost, larger scale energy storage.

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An inertial energy storage system, comprising:
a rotor system comprising a flywheel configured for storing rotational energy, wherein the flywheel has a high axial length to diameter ratio;
a generator operatively coupled to the rotor;
a bearing system configured to support the rotor system; and
a means for dampening dynamic instability associated with the rotor system comprising a gimbal system.

2. The inertial energy storage system of claim 1, wherein the flywheel has a longitudinal axis, wherein the flywheel is tapered from a proximal end to a distal end relative to the longitudinal axis such that the proximal end of the flywheel has a smaller diameter that the distal end of the flywheel, and wherein the proximal end of the flywheel is operatively coupled to the generator.

3. The inertial energy storage system of claim 2, wherein the bearing system comprises a thrust bearing.

4. The inertial energy storage system of claim 3, wherein the thrust bearing is selected from the group consisting of a passive magnetic thrust bearing and an active magnetic thrust bearing.

5. The inertial energy storage system of claim 3, wherein the thrust bearing comprises at least one superconducting magnet.

6. The inertial energy storage system of claim 3, wherein the bearing system further comprises at least one radial rolling element bearing.

7. The inertial energy storage system of claim 3, wherein the bearing system further comprises at least one radial magnetic bearing

8. The inertial energy storage system of claim 1, wherein the gimbal system is passively controlled.

9. The inertial energy storage system of claim 1, wherein the gimbal system comprises a one-axis gimbal system.

10. The inertial energy storage system of claim 1, wherein the gimbal system comprises a two-axis gimbal system.

11. The inertial energy storage system of claim 1, further comprising a processor electrically coupled to the gimbal system

12. The inertial energy storage system of claim 11, wherein the means for dampening dynamic instability further comprises sending an input signal indicative of at least one of position, velocity, or acceleration of the rotor system to the processor.

13. The inertial energy storage system of claim 12, wherein the processor processes the input signal and sends an output signal to the gimbal system such that the gimbal system counteracts at least a portion of the dynamic instability of the rotor system.

14. The inertial energy storage system of claim 13, wherein the gimbal system comprises at least one hydraulic actuator.

15. The inertial energy storage system of claim 13, wherein the gimbal system comprises at least one electromechanical actuator.

16. The inertial energy storage system of claim 13, wherein the gimbal system comprises at least one electromagnetic actuator.

17. The inertial energy storage system of claim 1, wherein the axial length to diameter ratio is at least 100/1.

18. The inertial energy storage system of claim 1, wherein the axial length to diameter ratio is at least 40/1.

19. The inertial energy storage system of claim 1, wherein the axial length to diameter ratio is at least 5/1.

20. An inertial energy storage system, comprising:
a generator;
a rotor system comprising a flywheel configured for storing rotational energy;
a bearing system configured to support the rotor system; and
a means for operatively coupling the rotor system to the generator such that the rotor system and the generator are substantially co-axially aligned.

21. The inertial energy storage system of claim 20, wherein the means for operatively coupling the rotor system comprises a quill shaft operatively connected to the generator and the rotor system.

22. The inertial energy storage system of claim 21, wherein the rotor system further comprises an arbor, wherein the arbor is configured for attaching the flywheel to the quill shaft.

23. The inertial energy storage system of claim 22, wherein the means for operatively coupling the rotor system to the generator further comprises a mechanical adjustment means, and wherein the mechanical adjustment means is configured to permit the arbor and the quill shaft to be substantially co-axially aligned.

24. The inertial energy storage system of claim 23, further comprising a means for dampening dynamic instability associated with the rotor system, the means comprising a gimbal system.

25. The inertial energy storage system of claim 24, wherein the means for dampening dynamic instability further comprises a processor electrically coupled to the gimbal system.

26. The inertial energy storage system of claim 25, wherein the means for dampening dynamic instability further comprises sending a signal indicative of at least one of position, velocity, or acceleration of the rotor system to the processor.

27. The inertial energy storage system of claim 23, wherein the flywheel has a longitudinal axis, wherein the flywheel is tapered from a proximal end to a distal end relative to the longitudinal axis such that the proximal end of the flywheel has a smaller diameter that the distal end of the flywheel, and wherein the proximal end of the flywheel is operatively coupled to the generator.

28. An inertial energy storage system, comprising:
a generator;
a rotor system comprising a flywheel configured for storing rotational energy, wherein the flywheel has a axial length to diameter ratio that ranges from between about 100/1 to about 5/1;
a generator operatively coupled to the rotor;
a bearing system configured to support the rotor system;
a means for operatively coupling the rotor system to the generator such that the rotor system and the generator are substantially co-axially aligned; and
a means for dampening dynamic instability associated with the rotor system comprising a gimbal system.
